(19) United States
(12) Patent Application Publication
(10) Pub. No.: US 2026/0221025 A1
(43) Pub. Date: Jul. 30, 2026

(54) METHOD FOR OPERATING A PASSENGER COMPARTMENT MONITORING APPARATUS, PASSENGER COMPARTMENT MONITORING APPARATUS, AND A VEHICLE

(71) Applicant: MERCEDES-BENZ GROUP AG, Stuttgart (DE)

(72) Inventors: Till HEINRICH, Stuttgart (DE); Michael KRAUSE, Hemmingen (DE)

(21) Appl. No.: 19/141,692

(22) PCT Filed: Nov. 14, 2023
(86) PCT No.: PCT/EP2023/081716

§ 371 Date: Jun. 20, 2025

(30) Foreign Application Priority Data
Dec. 22, 2022 (DE) 10 2022 004 877.9

(51) Int. Cl. G08B 29/18; B60R 25/10; B60R 25/31; B60R 25/32

(52) U.S. Cl. CPC G08B 29/183; B60R 25/1003; B60R 25/31; B60R 25/32

(57) ABSTRACT

A passenger compartment monitoring apparatus detects movements in the interior of a vehicle and triggers a vehicle alarm depending on a detected movement. The vehicle measures acceleration of the vehicle structure using an acceleration sensor and considers the measured acceleration value for operating the passenger compartment monitoring apparatus. The vehicle determines a parking status and activates the passenger compartment monitoring apparatus if a parked status has been determined. The vehicle suppresses a vehicle alarm to be output on detection of a movement in the interior if the vehicle detects acceleration excitation of the vehicle structure at the same time as detecting the movement in the interior.

### BACKGROUND AND SUMMARY OF THE INVENTION

Exemplary embodiments of the invention relate to a method for operating a passenger compartment monitoring apparatus, a passenger compartment monitoring apparatus, and to a vehicle having such a passenger compartment monitoring apparatus.

To increase comfort and security, passenger compartment monitoring apparatuses are known. The presence and movement of objects in the vehicle interior can be detected with the aid of a sensor system. This can be used to output an alarm when a living being, for example children or pets are forgotten in the vehicle. It can also form an anti-theft alarm system in which an alarm is output when movement of an object is detected in the passenger compartment. The output of an acoustic alarm is possible by means of the horn of the vehicle, for example. The output of a visual alarm is possible by activating the vehicle headlights, rear lights and/or direction indicators.

In this case, false alarms can occur. For instance, a corresponding vehicle can be initiated from the outside to move, whereby objects that are loose in the vehicle, such as for example a water bottle stored on the back seat, begin to move. The movement of the loose object is then detected and the alarm is accordingly triggered. Thus, there is the need to provide a method and means which can reduce or completely avoid the occurrence of such false alarms.

A passenger compartment security system and a method for its operation is known, for example, from DE 10 2021 102 963 A1. The vehicle described in the document comprises acceleration sensors, with the aid of which a movement state of the vehicle is determined. If the vehicle detects that it is driving, a corresponding passenger compartment monitoring apparatus remains deactivated. In contrast, if the vehicle detects that it has been parked, the passenger compartment monitoring apparatus can be automatically activated.

Exemplary embodiments of the present invention are directed to an improved method for operating a passenger compartment monitoring apparatus, with the aid of which the occurrence of false alarms can be reduced or completely prevented.

According to the invention, this achieved by a method for operating a passenger compartment monitoring apparatus, a corresponding passenger compartment monitoring apparatus, and a vehicle having such a passenger compartment monitoring apparatus result from the claims dependent thereon.

A generic method for operating a passenger compartment monitoring apparatus, wherein the passenger compartment monitoring apparatus is set up to detect movements in the interior of a vehicle and to trigger a vehicle alarm depending on a detected movement, wherein the vehicle measures the acceleration of the vehicle structure by means of at least one acceleration sensor and takes into consideration a measured acceleration value for operating the passenger compartment monitoring apparatus, and wherein the vehicle determines a parking status and activates the passenger compartment monitoring apparatus if a parked status has been determined, is further developed according to the invention in that the vehicle suppresses a vehicle alarm to be output on detection of a movement in the interior if the vehicle detects acceleration excitation of the vehicle structure at the same time as detecting the movement in the interior.

The method according to the invention enables the prevention of the output of false alarms in a particularly simple and reliable way. For this purpose, the vehicle checks whether the vehicle is excited externally to move, whereby correspondingly loose objects in the vehicle interior can begin to move. If movement is detected in the passenger compartment which is attributed to acceleration excitation of the vehicle structure, the vehicle does not output the vehicle alarm.

Along with the activation of the horn of the vehicle or the output of signal tones via external vehicle loudspeakers and the activation of a lighting device of the vehicle, such as headlights, rear lights or direction indicators, an alarm notification can also be wirelessly triggered as a vehicle alarm. The alarm notification can be sent indirectly by mobile radio, for example, over the internet to a central computing device, such as a cloud server. The vehicle owner can have a mobile end device, such as a smartphone, which is also connected to the central computing device via a suitable application. The alarm notification output by the vehicle can be passed on to the mobile end device of the vehicle owner via the central computing device.

Acceleration sensors already installed in the vehicle can be used as an acceleration sensor, for example an acceleration sensor used by an ESP or airbag. This enables particularly simple and cost-effective realization of the method according to the invention in the vehicle.

The vehicle uses diverse computing units, such as a central computing unit, the control device of a vehicle subsystem, a telematics unit, and similar, for carrying out the described method steps. The computing units receive sensor data from sensors and exchange information among each other via a data bus.

This means that the vehicle is able to determine the parking status. To do this, the vehicle or corresponding computing units can monitor an ignition status of the drive engine of the vehicle, request a steering wheel lock status, request a door locking status, and/or check a vehicle speed or vehicle acceleration value. In this way, a computing unit of the vehicle determines the parked status, for example, when the vehicle stands still, on-board electronics are switched to standby and the vehicle doors are locked.

The suppression of the vehicle alarm takes place when the movement in the interior is detected at the same time as acceleration excitation. In this context, at the same time means that the acceleration excitation and the movement detected in the interior take place simultaneously or also the acceleration excitation of the vehicle structure takes place with a certain time delay before the movement detected in the passenger compartment. This time delay is comparatively small and, for example, is of a magnitude of a few seconds or milliseconds. A value for a tolerable time delay can be fixed by the vehicle manufacturer.

An advantageous further development of the method provides that the vehicle measures translational acceleration in the direction of the and/or rotary acceleration around the vehicle longitudinal axis, the vehicle transverse axis, and/or the vehicle vertical axis. This means that the vehicle is able to understand exactly its state of motion in every spatial direction. This enables a particularly comprehensive assessment of the acceleration excitation of the vehicle structure. In this case, individual acceleration sensors can be provided for each of the different spatial directions and rotational directions.

According to a further advantageous embodiment of the method, the vehicle compares a measured acceleration value with a specified acceleration limit value and only suppresses the vehicle alarm when the measured acceleration value is greater than the acceleration limit value. In other words, therefore, if the vehicle is accelerated only comparatively weakly and movement is nevertheless detected in the passenger compartment, the vehicle alarm can still then be output. This means that it can be avoided that a vehicle alarm is incorrectly suppressed. The following example illustrates this: The vehicle parks next to a busy road. A child is sat on the back seat in the vehicle. Then, an HGV drives past the vehicle at a high speed, which causes the vehicle to roll around the vehicle longitudinal axis. The child is frightened by the passing HGV and jumps, whereby a movement in the interior is detected. In this case, it can still be advantageous to output the vehicle alarm.

In this case, different acceleration limit values can be defined for the translational or rotational accelerations in the direction or around the vehicle longitudinal axis, vehicle transverse axis and vehicle vertical axis.

A further advantageous embodiment of the method according to the invention also provides that the vehicle detects an acceleration pattern by evaluating an acceleration direction curve of the acceleration imposed on the vehicle structure over time, detects a movement pattern by evaluating a movement direction curve of the objects moving in the interior over time, compares the acceleration pattern with the movement pattern, and only suppresses the vehicle alarm when the movement pattern correlates with the acceleration pattern. This means that a more reliable performance of the method according to the invention can be enabled. The vehicle, that is to say a computing unit, checks whether the movement detected in the passenger compartment also matches the acceleration excitation of the vehicle structure. For example, if an HGV passes a parked vehicle, which causes the rolling oscillations around the vehicle longitudinal axis, then typically objects located in the interior are moved translationally in the direction of the vehicle transverse axis. The excitation of the vehicle by the passing HGV corresponds in this case to an excitation impulse. Thus, an object located in the vehicle would initially have begun to move vigorously, with the movements slowly subsiding in the form of a dampened oscillation due to the lack of excitation. In contrast, if another movement pattern is detected in the interior, for example a movement in the vehicle longitudinal direction and this movement does not subside with a typical decay pattern, the vehicle alarm can still be output.

A vehicle transported on a ferry is described as a further example. Due to the wave movement of the water, the ferry oscillates back and forth. These oscillations are characterized accordingly as acceleration of the vehicle structure, and are passed on to objects that are loose in the passenger compartment, which then begin to move. The vehicle can then detect the acceleration pattern of the vehicle structure, induced by the wave movement, and can compare this with the movement curve of the loose objects in the passenger compartment. For example, if a loose drinking bottle will continually roll back and forth on the vehicle back seat with a specific frequency in the direction of the vehicle transverse axis. The vehicle takes into consideration in particular the phase shift between acceleration excitation of the vehicle structure and the movement of the loose object.

In other words, specific movement patterns can be detected in the passenger compartment. The recorded acceleration pattern can then be laid like a filter over the detected movement pattern, in order to filter out the influence of the excitation on the movement.

According to a further advantageous embodiment of the method, the vehicle deactivates the passenger compartment monitoring apparatus for as long as the vehicle detects acceleration excitation of the vehicle structure over an excitation period above a specified buffer time period. The objects are set in motion in the passenger compartment due to the vehicle excitation, which makes the detection of occupants based on movement detection obsolete. The corresponding sensor system can be advantageously deactivated in such a situation in order to save energy. After the excitation of the vehicle falls away, then the passenger compartment monitoring apparatus can be automatically activated again.

A further advantageous embodiment of the method according to the invention provides that the passenger compartment monitoring apparatus detects a breathing pattern of a living being in the interior and classifies this as movement. This means that an object can be differentiated from a living being, which enables a differentiation between vehicle alarms. Thus, for example, a vehicle alarm can be suppressed when the movements of objects are detected, but the vehicle alarm is output when the presence of a living being is detected in the passenger compartment. The rise and fall of the breast of the living being can be detected and analyzed for recognizing breathing patterns. This rise and fall also takes place with a characteristic movement sequence.

A passenger compartment monitoring apparatus, comprising at least one movement sensor, is set up according to the invention to carry out a method described above. The passenger compartment monitoring apparatus can possess a dedicated computing unit, to which the corresponding movement sensors are connected. However, equipment that is present anyway in the vehicle can be used for forming the passenger compartment monitoring apparatus. For this purpose, corresponding program code set up for performing a method as described above is implemented on an already existing computing unit.

Preferably, the at least one movement sensor of the passenger compartment monitoring apparatus is set up to generate depth information using the Doppler principle, in particular based on electromagnetic waves or sound waves. Thus, the passenger compartment monitoring apparatus can be, for example, a radar sensor or a radar sensor system and/or an ultrasound sensor or an ultrasound sensor system as a movement sensor. In this case, they are comparatively simple and cost-effective sensors, which further favors a simple and cost-effective implementation of the passenger compartment monitoring apparatus in the vehicle.

In general, however, other sensor systems are also eligible for detecting movements in the passenger compartment. In particular, reliable living being detection is possible with the aid of a WiFi antenna array. For instance, different WiFi antennae are fitted at different places in the vehicle, which enable spatial evaluation of a radio signal strength of the WiFi signal in the passenger compartment. The WiFi signal is influenced by the movements of vehicle occupants, whereby even the heartbeat of people can be recognized and can be used to locate them in the vehicle. Such a sensor system is however complex and thus complicated and expensive.

According to the invention, a vehicle comprises a passenger compartment monitoring apparatus as described above. The vehicle can be any vehicle such as a car, lorry, van, bus or similar.

Further advantageous embodiments of the method according to the invention for operating a passenger compartment monitoring apparatus result from the exemplary embodiments which are described in more detail below with reference to the figures.

### BRIEF DESCRIPTION OF THE DRAWING FIGURES

Here the figures show:

FIG. 1 a schematic plan view of a vehicle according to the invention on a ferry; and

FIG. 2 a roll angle plot, showing the roll angle of the vehicle structure, of the vehicle represented in FIG. 1, over time as a result of the wave movement of the ferry and a position plot, showing the time curve of the position of a drinking bottle moving back and forth in the rear of the vehicle due to the rolling movement of the vehicle.

### DETAILED DESCRIPTION

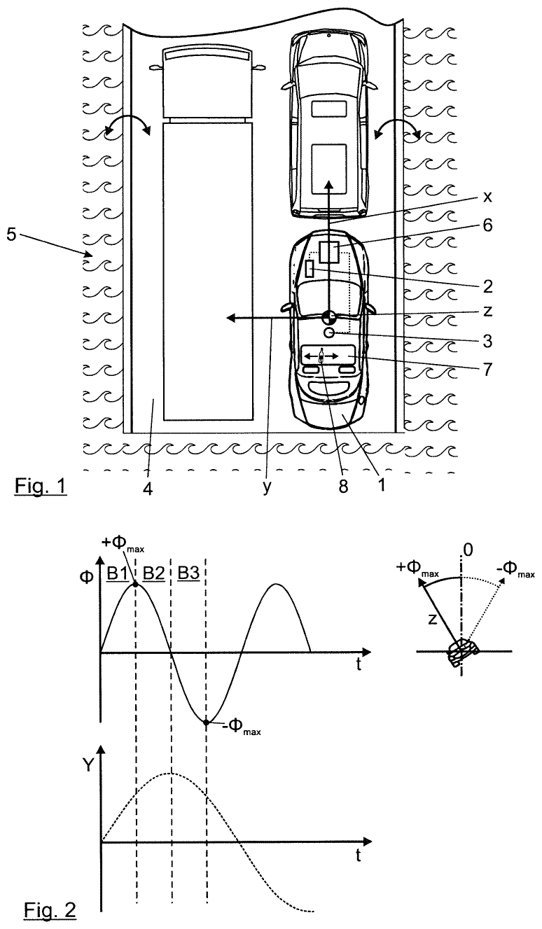

FIG. 1 shows a vehicle 1 according to the invention, which is transported on a ferry 4 over a body of water 5. Due to the wave movement of the body of water 5, the vehicle 1 performs rolling movements around the vehicle longitudinal axis x, as illustrated by the arrows, together with the ferry 4. Also shown are the transverse axis y and the vertical axis z of the vehicle 1.

The vehicle 1 according to the invention comprises a passenger compartment monitoring apparatus. Parts of the passenger compartment monitoring apparatus are a computing unit 6, a movement sensor 3, which serves to monitor the passenger compartment and is set up to detect movement in the passenger compartment, and at least one acceleration sensor 2 of the vehicle 1, with the aid of which the computing unit 6 can measure acceleration imposed on the vehicle 1.

The passenger compartment monitoring apparatus serves to initiate the output of a vehicle alarm when movements are detected in the passenger compartment when a vehicle 1 is parked. This could specifically be an indication of a forgotten living being or a break-in. A loose object, such as a drinking bottle 8 lying on the back seat 7 of the vehicle 1, can however be set in motion when the vehicle 1 is moved, which can be measured with the aid of the acceleration sensor(s) 2 due to acceleration being imposed.

According to the invention, the vehicle 1 according to the invention or the computing unit 6 suppresses the output of a vehicle alarm when acceleration imposed on the vehicle structure of the vehicle 1 is detected at the same time as detection of a movement in the interior of the vehicle 1.

The computing unit 6 can then compare an observed movement pattern with an observed acceleration pattern and only suppress the output of the vehicle alarm if the two patterns correlate. To this end, FIG. 2 shows a roll angle plot of the vehicle 1 around the longitudinal axis x over time t and the corresponding position plot of the drinking bottle 8. The plot at the top in FIG. 2 shows the roll angle Φ and the lower plot shows the position Y of the drinking bottle 8 on the back seat 7 in the direction of the vehicle transverse axis y. Similarly represented is the maximum deflection of the vehicle 1 due to the rocking motion in both directions, referred to as +Φₘₐₓ and −Φₘₐₓ.

The respective curves of roll angle and position can be determined from time integration of measured acceleration or speed variables. Analogously, acceleration and speed curves can be determined by differentiating position values measured temporally one after the other.

The roll angle plot illustrates the rolling of the vehicle 1 according to the wave movement. The roll angle therefore correlates to a sine wave.

The drinking bottle 8 follows this rolling oscillation, wherein the rolling speed of the drinking bottle 8 increases with an increasing roll angle, so that the drinking bottle moves faster and faster in the direction of the vehicle transverse axis y and thus covers a greater distance in shorter time periods. This corresponds to the region B1 in the plots.

The movement direction is reversed and the vehicle 1 oscillates in the opposing direction. The region B2 corresponds to the region in front of the zero crossing. The drinking bottle 8 continues to be accelerated, but more slowly.

In the region B3, the ferry 4 oscillates and thus the vehicle 1 oscillates to the other side, whereupon the drinking bottle 8 is braked and then is also accelerated in the other direction. Due to the mass inertia, the drinking bottle 8 can roll further. Additionally, the drinking bottle 8 can stop abruptly when it reaches the end of the back seat 7 and abuts the vehicle door.

This characteristic movement behavior of the vehicle structure and drinking bottle 8 shown in FIG. 2 is recognized by the computing unit 6, so that a correlation can be recognized between the acceleration of the vehicle 1 and the movement of the object moving back and forth in the passenger compartment. Thus, a vehicle alarm is not output.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method comprising:
determining, by a vehicle, that a parking status of the vehicle is a parked status;
activating, by the vehicle responsive to determining the parking status of the vehicle is the parked status, a passenger compartment monitoring apparatus of the vehicle;
detecting, by the passenger compartment monitoring apparatus of a vehicle, movements in an interior of the vehicle;
measuring, using at least one acceleration sensor of the vehicle, acceleration of a structure of the vehicle; and
determining whether to trigger or suppress a vehicle alarm of the vehicle,
wherein it is determined to suppress the vehicle alarm when the at least one acceleration sensor of the vehicle detects an acceleration excitation of the structure of the vehicle at a same time as the movements in the interior of the vehicle are detected.

11. The method of claim 10, wherein the vehicle measures translational acceleration in a direction of the vehicle or measures rotary acceleration around a longitudinal axis of the vehicle, a transverse axis of the vehicle, or a vertical axis of the vehicle.

12. The method of claim 10, wherein the vehicle compares the measured acceleration with a specified acceleration limit value and only suppresses the vehicle alarm when the measured acceleration is greater than the specified acceleration limit value.

13. The method of claim 10, further comprising:
detecting, by the vehicle, an acceleration pattern by evaluating an acceleration direction curve of the measured acceleration of the structure of the vehicle structure over time;
detecting, by the vehicle, a movement pattern by evaluating a movement direction curve of objects moving in the interior of the vehicle over time; and
comparing, by the vehicle, the acceleration pattern with the movement pattern,
wherein the vehicle alarm is only suppressed when the movement pattern correlates with the acceleration pattern.

14. The method of claim 10, further comprising:
deactivating, by the vehicle, the passenger compartment monitoring apparatus when the vehicle detects an acceleration excitation of the structure of the vehicle over an excitation period above a specified buffer time period.

15. The method of claim 10, wherein the passenger compartment monitoring apparatus detects a breathing pattern of a living being in the interior of the vehicle and classifies the detected breathing pattern as movement.

16. A passenger compartment monitoring apparatus for a vehicle, the passenger compartment monitoring apparatus comprising:
at least one movement sensor configured to detect movements in an interior of the vehicle,
wherein the passenger compartment monitoring apparatus is configured to be activated responsive to the vehicle having a parking status of a parked status,
wherein the passenger compartment monitoring apparatus is configured to suppress an alarm of the vehicle when at least one acceleration sensor of the vehicle detects an acceleration excitation of a structure of the vehicle at a same time as the movements in the interior of the vehicle are detected.

17. The passenger compartment monitoring apparatus of claim 16, wherein the at least one movement sensor is configured to generate depth information using Doppler principle.

18. A vehicle comprising:
a vehicle alarm;
at least one acceleration sensor configured to measure acceleration of a structure of the vehicle; and
a passenger compartment monitoring apparatus comprising at least one acceleration sensor configured to measure acceleration of a structure of the vehicle,
wherein the vehicle is configured to determine that a parking status of the vehicle is a parked status and activate, responsive to determining the parking status of the vehicle is the parked status, the passenger compartment monitoring apparatus,
wherein the passenger compartment monitoring apparatus is configured to detect movements in an interior of the vehicle, and
wherein the vehicle is configured to suppress triggering of the vehicle alarm when the at least one acceleration sensor of the vehicle detects an acceleration excitation of the structure of the vehicle at a same time as the movements in the interior of the vehicle are detected.
